(19) United States
(12) Patent Application Publication
(10) Pub. No.: US 2017/0297683 A1
(43) Pub. Date: Oct. 19, 2017

(54) NOSE GEAR STEERING APPARATUS FOR SHIPBOARD OPERATIONS

(71) Applicant: SIKORSKY AIRCRAFT CORPORATION, Stratford, CT (US)

(72) Inventors: William E. Hovan, Oxford, CT (US); Andrew Varga, Milford, CT (US); Christopher A. Bresh, West Haven, CT (US); Jeffrey E. Hunt, Middlebury, CT (US); John Boath, Shelton, CT (US); Peter Kummer, Milford, CT (US); David Klusek, Guilford, CT (US); David A. Houser, Danbury, CT (US); Ramon Estevez, Lawrence, MA (US); Jay Hurley, Monroe, CT (US); Todd Haeg, Hamden, CT (US)

(21) Appl. No.: 15/374,232

(22) Filed: Dec. 9, 2016

Related U.S. Application Data
(60) Provisional application No. 62/293,115, filed on Feb. 9, 2016.

(51) Int. Cl. B64C 25/50; B64C 27/04

(52) U.S. Cl. CPC B64C 25/50; B64C 27/04

(57) ABSTRACT

A steering assembly includes a movable anchor. Movement of the anchor in a first direction is restricted. A first linkage is coupled to the anchor and a second linkage it rotatably coupled to the first linkage. The second linkage is configured to couple to a contactor. A drive mechanism moves the second linkage relative to the first linkage. At least one of moving the second linkage and moving the anchor maneuvers the contactor to a desired position.

### CROSS-REFERENCE TO RELATED APPLICATION

This application claims the benefit of U.S. provisional patent application Ser. No. 62/293,115 filed Feb. 9, 2016, the entire contents of which are incorporated herein by reference.

### STATEMENT REGARDING FEDERALLY SPONSORED RESEARCH OR DEVELOPMENT

This invention was made with Government support under Technology Investment Agreement No. W8470-01MP01/001. The Government has certain rights in the invention.

### BACKGROUND

The subject matter disclosed herein generally relates to an aircraft, and more particularly, to a system for steering a grounded aircraft to park the aircraft within a hangar.

Alignment and parking of a shipboard aircraft at a desired location within a hangar on a ship or vessel requires substantial maneuvering of the aircraft. The ship typically includes a rapid securing device (RSD) for detecting that an aircraft has landed on the deck of the ship and then automatically securing the aircraft to the deck. The aircraft includes a recovery assist, secure, and traverse (RAST) probe configured to cooperate with the RSD to move the aircraft fore and aft along the deck. In addition, multiple winches mounted to the deck are attached to one or more tie down rings of the aircraft and move the aircraft laterally. The fore and aft and lateral movement of the aircraft may be coordinated through multiple maneuvers to cause the nose landing gear of the aircraft to castor until the aircraft is arranged at a desired position within the hangar. However, this movement of the aircraft is complex and time consuming, and the forces applied by the winches to turn the aircraft can exceed the structural capability of the tie down rings.

### BRIEF DESCRIPTION

According to one embodiment, a steering assembly includes a movable anchor. Movement of the anchor in a first direction is restricted. A first linkage is coupled to the anchor and a second linkage is movably coupled to the first linkage. The second linkage is configured to couple to a contactor. A drive mechanism moves the second linkage relative to the first linkage. At least one of moving the second linkage and moving the anchor maneuvers the contactor to a desired position.

In addition to one or more of the features described above, or as an alternative, further embodiments at least one of moving the second linkage relative to the first linkage and moving the anchor is operated remotely.

In addition to one or more of the features described above, or as an alternative, further embodiments the drive mechanism includes a pulley operably coupled to the second linkage, and a belt drive for driving moving the second linkage relative to the first linkage.

In addition to one or more of the features described above, or as an alternative, further embodiments the drive mechanism includes a hydraulic or pneumatic actuator.

In addition to one or more of the features described above, or as an alternative, further embodiments the anchor is arranged within a track.

In addition to one or more of the features described above, or as an alternative, further embodiments the second linkage is connected to an axle of the contactor.

In addition to one or more of the features described above, or as an alternative, further embodiments the contactor is a landing gear of an aircraft.

In addition to one or more of the features described above, or as an alternative, further embodiments the aircraft is a rotary wing aircraft.

In addition to one or more of the features described above, or as an alternative, further embodiments the aircraft is a fixed wing aircraft.

According to another embodiment, a method of maneuvering an aircraft into a desired position includes affixing a steering assembly to a contactor of the aircraft. The steering assembly includes an anchor, a first linkage connected to the anchor, and a second linkage coupled to the first linkage. The second linkage is moved relative to the first linkage to steer the contactor of the aircraft.

In addition to one or more of the features described above, or as an alternative, further embodiments the anchor is configured to move fore and aft with the aircraft, and wherein at least one of moving the second linkage relative to the first linkage and moving the anchor is controlled remotely.

In addition to one or more of the features described above, or as an alternative, further embodiments moving the second linkage is driven by a drive mechanism.

In addition to one or more of the features described above, or as an alternative, further embodiments the steering assembly is affixed to an axle of the contactor

In addition to one or more of the features described above, or as an alternative, further embodiments the second linkage is affixed to the contactor.

In addition to one or more of the features described above, or as an alternative, further embodiments at least one of moving the second linkage and moving the anchor is repeated.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of an example of a rotary wing aircraft;

FIG. 2 is a perspective view of a steering assembly for maneuvering a rotary wing aircraft according to an embodiment; and

FIG. 3 is a schematic diagram illustrated the various positions of a rotary wing aircraft as the steering assembly moves the aircraft to a desired position according to an embodiment.

The detailed description explains embodiments of the disclosure, together with advantages and features, by way of example with reference to the drawings.

### DETAILED DESCRIPTION

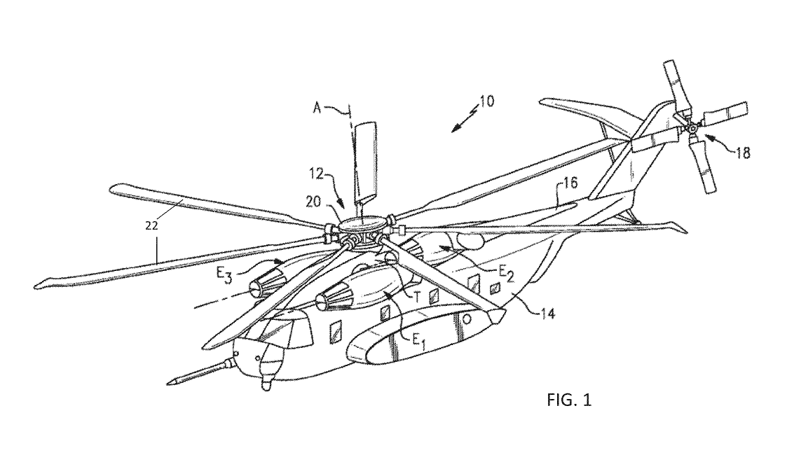

FIG. 1 schematically illustrates an example of a rotary wing aircraft 10 having a main rotor assembly 12. The aircraft 10 includes an airframe 14 having an extending tail 16 which mounts a tail rotor system 18. While shown as an anti-torque system, it is understood the tail rotor system 18 can be a translational thrust system, a pusher propeller, a rotor propulsion system, and the like in addition to or instead of the shown anti-torque system. The main rotor assembly 12 includes a plurality of rotor blade assemblies 22 mounted to a rotor hub 20. The main rotor assembly 12 is driven about an axis of rotation A through a main gearbox (illustrated schematically at T) by one or more engines E. Although a particular helicopter configuration is illustrated and described in the disclosed embodiment, other configurations and/or machines, such as high speed compound rotary wing aircrafts with supplemental translational thrust systems, dual contra-rotating, coaxial rotor system aircrafts, tilt-rotors and tilt-wing aircrafts, and fixed wing aircrafts, will also benefit from embodiments of the disclosure.

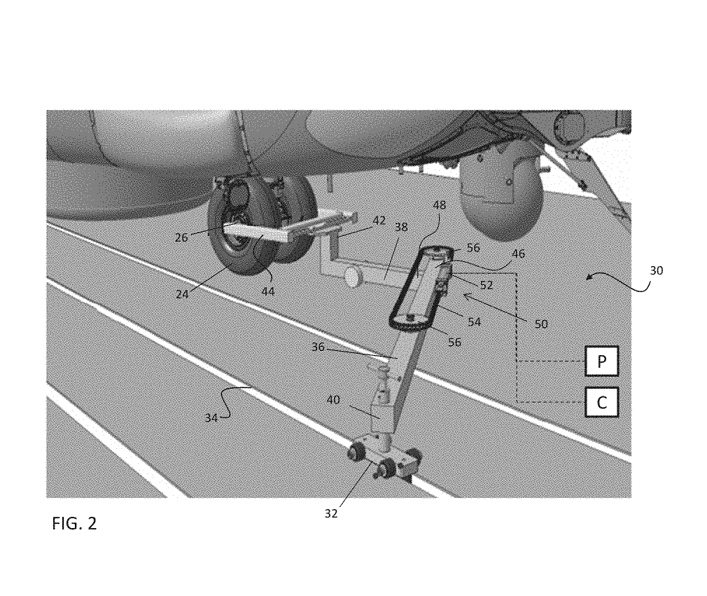

Referring now to FIG. 2, a steering assembly 30 for positioning an aircraft, such as a rotary wing aircraft 10 for example, within a hangar is illustrated. Although the steering assembly 30 is illustrated and described with respect to positioning of an aircraft in a hangar on a ship or vessel, it should be understood that the steering assembly 30 may be used in any application where maneuvering of an aircraft to arrange the aircraft at a desired position within a confined space is required. The steering assembly 30 includes an anchor 32 wherein movement of the anchor 32 along at least one directional axis is restricted. In the illustrated, non-limiting embodiment, the anchor 32 is arranged within a linear track 34 formed in the ground, or in the deck of a ship or vessel in embodiments where the aircraft 10 is a shipboard aircraft. The anchor 32 is free to translate along the path defined by the track 34, such as when the aircraft moves fore and aft for example. However, sideways movement of the anchor 32, such as in a direction perpendicular to the longitudinal axis of the track 34 for example, is restricted. Although the anchor 32 is described as being driven within the track 34 by movement of the aircraft, embodiments where a motor or other device (not shown) is used to drive the anchor 32 is also considered within the scope of the disclosure.

The steering assembly 30 additionally includes a first linkage 36 and a second linkage 38. The first linkage 36 is pivotally mounted at a first end 40 to the anchor 32 such that as the anchor 32 translates in a first direction, such as defined by track 34, the first linkage 36 may rotate relative thereto. A first end 42 of the second linkage 38 is configured to couple to a movable contactor 24, such as a landing gear of an aircraft 10. As shown, the distal end 42 of the second linkage 38 may include a gear interface 44 connectable to one or both sides of an axle 26 of the landing gear 24 adjacent the nose of the aircraft 10, to apply a force to the landing gear 24 to move the aircraft 10 in a desired direction. The second ends 46, 48 of the first linkage 36 and second linkage 38 are movably connected to one another, such as with a pin (not shown) for example. As a result of this connection between the first and second linkage 36, 38, the second linkage 38 may be movable, such as rotatable for example, between a retracted position, substantially parallel to and in a generally overlapping arrangement with the first linkage 36, and an extended position, where the second linkage 38 is arranged at an angle to the first linkage 36. The second linkage 38 may be arranged in the retracted position for storage, or when the steering assembly 30 is not in use.

A drive mechanism 50 is configured to drive rotation of the second linkage 38 relative to the first linkage 36 to move the landing gear 24 towards a desired position. In the illustrated, non-limiting embodiment, the drive mechanism 50 includes a motor 52 configured to drive a continuous belt or chain 54 about two or more pulleys or sprockets 56. Although illustrated as a separate component, in other embodiments, the motor 52 may be integrally formed into one of the pulleys 56. The motor 52 may be connected to external power source, illustrated schematically at P in FIG. 2, such as a power outlet provided in a nearby wall or other structure. In some embodiments, the external power source P may be mounted to a portion of the steering assembly 30, such as the first linkage 36 for example. Alternatively, or in addition, the steering assembly 30 may include a rechargeable power source, such as a battery for example.

By mounting one of the pulleys or sprockets 56 at the connection between the first and second linkages 36, 38, operation of the motor 52, and therefore rotation of the pulley 56 driven by the belt 54, causes a similar rotation of the second linkage 38. In one embodiment, the motor 52 is configured to drive the belt 54 in a forward and backwards direction to move the second linkage 38 between the retracted and extended positions. It should be understood that the drive mechanism 50 illustrated and described herein is intended as an example only, and that other types of drive mechanisms 50, such as a hydraulic or pneumatic actuator for example, are also within the scope of the disclosure.

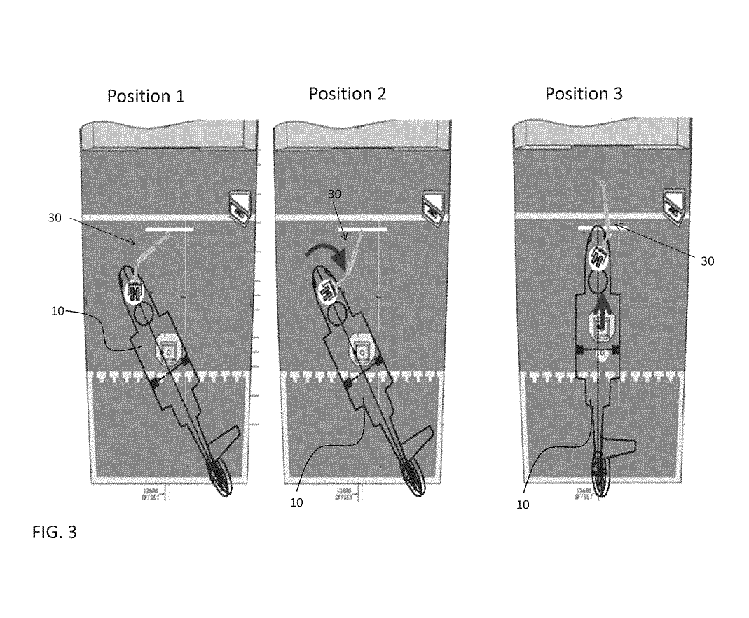

As best shown in FIG. 3, movement of the second linkage 38 is configured to apply a force to landing gear 24 to steer the nose of the aircraft 10 laterally side to side, illustrated by the arrow in Position 2, and in some instances at least partially fore and aft. In addition, the anchor 32 is configured to move within the linear track 34, as indicated by the arrow in Position 3. This movement is driven by the fore and aft movement of the aircraft 10. Accordingly, movement of the second linkage 38 relative to the first linkage 36 to a desired angular position and movement of the anchor 32 may be coordinated to drive the aircraft 10 to a desired position within a hangar.

With reference again to FIG. 2, a controller, illustrated schematically at C in FIG. 2, is operably coupled to the drive mechanism 50, specifically to the drive motor 52, to control movement of the second linkage 38 relative to the first linkage 36. Operation of steering assembly 30 may be controlled remotely, such as by an operator arranged at another location of the vessel, distinct from the hangar. In one embodiment, the steering assembly 30 includes, or alternatively is arranged in communication with, one or more sensors configured to identify a current position of the aircraft 10. With the information from these sensors, the one or more controllers C may be configured to determine a sequence of required movements of both the second linkage 38 and the anchor 32 to locate the aircraft 10 at a desired position within the hangar. In addition, the controller C may be configured to automatically perform the sequence of required movements, or alternatively, to display the sequence of movements to an operator.

The steering assembly 30 illustrated and described herein is smaller, lighter weight, and more easily maneuvered than conventional steering systems. The remote operability of the steering assembly 30 eliminates the need for personnel on the deck after the initial set up of the steering assembly 30 is complete, resulting in increased safety to the operator. In addition, because the steering assembly does not couple to the aircraft tie down rings, the previous failure due to overloading of these rings is eliminated.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A steering assembly, comprising:
a movable anchor, movement of the anchor in a first direction being restricted;
a first linkage coupled to the anchor;
a second linkage movably coupled to the first linkage, the second linkage being configured to couple to a contactor; and
a drive mechanism for moving the second linkage relative to the first linkage, wherein at least one of moving the second linkage and moving the anchor maneuvers the contactor to a desired position.

2. The steering assembly according to claim 1, wherein at least one of moving the second linkage relative to the first linkage and moving the anchor is operated remotely.

3. The steering assembly according to claim 1, wherein the drive mechanism includes a pulley operably coupled to the second linkage, and a belt drive for driving moving the second linkage relative to the first linkage.

4. The steering assembly according to claim 1, wherein the drive mechanism includes a hydraulic or pneumatic actuator.

5. The steering assembly according to claim 1, wherein the anchor is arranged within a track.

6. The steering assembly according to claim 1, wherein the second linkage is connected to an axle of the contactor.

7. The steering assembly according to claim 1, wherein the contactor is a landing gear of an aircraft.

8. The steering assembly according to claim 7, wherein the aircraft is a rotary wing aircraft.

9. The steering assembly according to claim 7, wherein the aircraft is a fixed wing aircraft.

10. A method of maneuvering an aircraft into a desired position, comprising:
affixing a steering assembly to a contactor of the aircraft, the steering assembly including an anchor, a first linkage connected to the anchor, and a second linkage coupled to the first linkage; and
moving the second linkage relative to the first linkage to steer the contactor of the aircraft.

11. The method according to claim 10, wherein the anchor is configured to move fore and aft with the aircraft, and wherein at least one of moving the second linkage relative to the first linkage and moving the anchor is controlled remotely.

12. The method according to claim 10, wherein moving the second linkage is driven by a drive mechanism.

13. The method according to claim 10, wherein the steering assembly is affixed to an axle of the contactor

14. The method according to claim 10, wherein the second linkage is affixed to the contactor.

15. The method according to claim 10, wherein at least one of moving the second linkage and moving the anchor is repeated.
